(19) United States
(12) Patent Application Publication
(10) Pub. No.: US 2004/0129696 A1
(43) Pub. Date: Jul. 8, 2004

(54) Induction heating roller device for use in image forming apparatus

(76) Inventors: Hiroyuki Doi, Yokohama-shi (JP); Ichiro Yokozeki, Yokosuka-shi (JP); Manabu Kika, Kamakura-shi (JP); Takayuki Ogasawara, Yokohama-shi (JP); Toshiya Suzuki, Yokosuka-shi (JP); Takaaki Tanaka, Yokosuka-shi (JP); Syouhei Maeda, Yokosuka-shi (JP)

Correspondence Address: JENKENS & GILCHRIST, A PROFESSIONAL CORPORATION, Steven R. Greenfield, 1445 Ross Avenue, Suite 3200, Dallas, TX, 75202, US

(21) Appl. No.: 10/733,028

(22) Filed: Dec. 11, 2003

(30) Foreign Application Priority Data
Dec. 18, 2002 (JP) 2002-367290
Dec. 18, 2002 (JP) 2002-367288

(51) Int. Cl. H05B 6/14

(52) U.S. Cl. 219/619

(57) ABSTRACT

An induction heating roller device that reduces noise emission to the outside and facilitates insulating between induction coils and nearby metal materials. The induction heating roller device includes a heating roller, a plurality of induction coils arranged in the axial direction of the heating roller, and a high-frequency power source for supplying high-frequency power to the plurality of induction coils. The high-frequency power source has a first output terminal set at a stable potential, and a second output terminal set at a non-stable potential. A pair of induction coils are arranged at the ends of the heating roller and a first end of the coils is positioned at the end of the heating roller and a second end of the coils is positioned in the central side of the heating roller. The first end of each of the two induction coils is connected to the first output terminal, and the second end of each of the two induction coils is connected to the second output terminal.

### BACKGROUND OF THE INVENTION

The present invention relates to an induction heating roller device, and to a fixing device and image forming apparatus provided with the induction heating roller device.

Conventionally, heating rollers using a halogen lamp as a heat source are employed to thermally fix a toner image. However, such heat sources are inefficient and require a large amount of power. Therefore, induction heating methods are being developed to resolve such problems.

The inventors of the present invention have developed an image forming apparatus and fixing device using an induction heating roller device of a transformer coupling type. The heating roller device includes a heating roller having a hollow structure in which an induction coil is air-core transformer coupled to an induction coil and rotatably supported. A secondary side resistance value of the heating roller is obtained from a closed circuit having a secondary reactance that is substantially equal to the secondary reactance. As a result, the transformer coupling type induction heating roller device effectively heats the heating roller. This invention conserves power used by the heating roller in induction heating and readily increases the speed of thermal fixing.

Many image forming apparatuses such as copiers, printers and the like have various sizes of paper selectable for use in forming images. Thus, in regard to this function, there is a need to change the heated region of the heating roller in accordance with the paper size.

In the transformer method, the heated region of the heating roller is variable in the axial direction by using induction coils of suitable structure for the heating roller. The induction coils are distributed in the axial direction of the heating roller and selectively driven. In this way, the aforesaid need can be met, and wasteful power consumption can be avoided by heating only the required region of the roller.

In the structure mentioned above, a plurality of induction coils must be arranged in mutual proximity in order to uniformly heat the heating roller in the axial direction. Furthermore, a high-frequency power source must be connected to each mutually independent induction coil so as to selectively drive the plurality of induction coils. Since a predetermined insulation distance corresponding to the difference in potential must be provided between the adjacent induction coils when there is a large difference in potential between adjacent induction coils, it is not possible to provide the spacing required to obtain the necessary temperature distribution.

The present inventors have made an invention for setting the relationship of the winding directions of a plurality of adjacent induction coils disposed within a heating roller and distributed in the axial direction of the roller such that the winding directions are mutually opposite, and the generated magnetic flux has the same polarity.

Induction heating roller devices have a problem of high frequency noise radiating from induction coils and power lines because a high-frequency current is supplied to the induction coils. In the case of an induction heating roller that is operated with a plurality of induction coils inserted into and distributed within the inner part of the heating roller, the noise must be suppressed since the noise radiates outside the device from the induction coil positioned at the two ends of the heating roller. Furthermore, an insulation treatment must be carried out between the induction coils positioned at the two ends of the heating roller and the metal material disposed nearby.

In the distribution of temperature along the axial direction of the heating roller, the temperature distribution at the two ends of the heating roller is important. That is, the temperature distribution at the two ends must be symmetrical. The two ends of the heating roller cool quickly. However, in order to effectively use the entire length of the heating roller, it is desirable that the temperature of the two ends be maintained at a high temperature similar to that at the central portion of the roller.

In the process of investigating the relationship between an induction coil and a heating roller, the present inventors understood that, even in the case of a single induction coil, the temperature of the heating roller will differ at different parts of the roller depending on the position of the induction coil due to the mode of connection to the output terminals of the high-frequency power source. That is, when one of a pair of output terminals of the high-frequency power source is grounded, the output terminal on the grounded side is set at a stable potential, whereas the output terminal of the non-grounded side is set at a non-stable potential. The temperature of the heating roller at the part corresponding to the end of the induction coil connected to the output terminal of non-stable potential is higher than the temperature of the heating roller at the part corresponding to the grounded terminal of the induction coil connected to the output terminal of stable potential. As a result, the temperature distribution of the heating roller opposite the induction coil tends to decrease from one end toward the other end. The reason this tendency occurs in the temperature distribution is not understood in detail, but it is likely that the distribution capacity is affected between the induction coil and the heating roller so as to produce irregular heating.

### SUMMARY OF THE INVENTION

A first object of the present invention is to provide an induction heating roller device, which reduces the noise radiating to the outside of the apparatus and facilitates insulating between the induction coils and the metal material disposed near the induction coils, and a fixing device and image forming apparatus provided with the induction heating roller device.

A second object of the present invention is to provide an induction heating roller device that facilitates insulating between a plurality of induction coils and reduces the intervals between adjacent induction coils to provide temperature distribution balanced in a satisfactory manner, and a fixing device and image forming apparatus provided with the induction heating roller device.

A third object of the present invention is to provide an induction heating roller device, which improves heating performance by not producing a degradation of the temperature distribution at the two ends of the heating roller to achieve substantially symmetrical temperature distribution, and a fixing device and image forming apparatus provided with the induction heating roller device.

In a first aspect of the present invention, the induction heating roller device includes a heating roller HR, and a plurality of induction coils arranged within the heating roller so as to be separated in the axial direction. The heating roller is magnetically coupled with the induction coils and heated by an induction current. The plurality of induction coils include a pair of induction coils, each having a first end positioned near an outer end portion of the heating roller and a second end positioned towards a central portion of the heating roller. A high-frequency power source supplies high-frequency power to the plurality of induction coils. The high-frequency power source has a first output terminal for setting a stable potential, and a second output terminal for setting a non-stable potential. The first end of each of the pair of induction coils is connected to the first output terminal, and the second end of each of the pair of induction coils is connected to the second output terminal.

In the present invention and each invention below, the definitions of terms are not specifically limited, and the technical meanings are described below.

[Heating Roller]

The heating roller is magnetically coupled with induction coils described later and generates heat by means of an induction current. For this reason, the heating roller is provided with a secondary coil to form a closed circuit in the circumferential direction, and the secondary coil is magnetically coupled with the induction coil, for example, an air-core transformer coupling. In the latter case, the secondary side resistance value of the closed circuit is a value substantially equal to the secondary reactance of the secondary coil. The “substantial equality” of the secondary side resistance value and the secondary reactance refers to a range satisfying Equation 1 as below, when the secondary side resistance value is designated Ra, the secondary reactance is designated Xa, and α=Ra/Xa. The reasons for stipulating this mathematical condition are disclosed in Japanese Patent Application No. 2001-016335 filed by the present inventors. The secondary side resistance value may be determined by measurement. The secondary reactance may be determined by calculation. The value α is a range of 0.25 to 4 times, and optimally a range of 0.5 to 2 times.

0.1<α<10 Equation 1

The heating roller may include an arrangement of one or more secondary coils. When there are a plurality of secondary coils, it is preferred that these secondary coils are arranged so as to be distributed in the axial direction. A roller base formed made of an insulating material may be used to support the secondary coils. In this case, the secondary coil may be arranged on the outer surface, the inner surface, or within the roller base.

According to the present invention, if desired, the heating roller may be configured to form heating ranges of a plurality of lengths corresponding to the size of the heated body. That is, when the heating roller is used to fix a toner image or the like, the heating roller is configured so as to change the heating region in accordance with the size of the paper. The change in the heating region is accomplished through cooperation with the induction coils as described later. The heating region is described below using toner image fixing as an example. For example, in the case of fixing a toner image on an A4 size sheet, when fixing the sheet vertically, the length of the required heating range differs from that when fixing the sheet horizontally. Furthermore, when fixing an A4 size sheet, for example, the width of the heating range also differs from that in the case of a B4 size sheet. Power is wasted by heating regions beyond that required for fixing while uniform heating is required within the necessary heating region. Furthermore, there may be instances of two different heating regions in which a part heated in common participates in the heating of both regions, and an independently heated part only participates in the heating of one or another of the heating regions. In the present invention, the mode of arrangement of the parts heated in common and the independently heated parts may include a mode of in-common heated parts arranged to either the left or right and independent heated parts biased in the other direction, and a mode of in-common heated parts arranged in the center with independent heated parts arranged on to the left and right of the center.

The secondary coil of the heating roller may be formed of a conductive member such as a conductive layer, a conductive wire, a conductive plate, and the like. The conductive layer may be formed using the following materials and manufacturing methods to obtain the desired secondary side resistance value. When a thick layer-forming method (application and calcination) is used, materials may be selected from among the group of Ag, Ag+Pd, Au, Pt, RuO₂, and C. Screen printing methods, roll coating methods, spray methods and the like may be employed as the application method. Conversely, when plating, deposition, and sputtering methods are used, materials may be selected from among the group of Au, Ag, Ni, and Cu+(Au, Ag). Conductive wires and conductive plates may use Cu, Al and the like. In the case of Cu and Al, it is desirable to form an anti-corrosion layer on the surface to prevent oxidation. When the roller base is formed of Fe and SUS (stainless steel), a surface layer of the roller base acts as a secondary coil due to high frequency surface effect. Accordingly, a special secondary coil need not be employed. However, even in this case, the roller base may have a separate secondary coil if necessary. Even in roller bases formed of Fe and SUS, an anticorrosive layer, such as a zinc layer, may be formed on the surface.

To obtain a more practical heating roller, it is desirable that the following structures be added.

1. Roller Base

A roller base formed of an insulating material may be used to support the secondary coil. In this case, the secondary coil may be arranged at the outer surface, inner surface, or inside the roller base. The insulated roller base may be formed using ceramics or glass. In considering the heat resistance, strong impact resistant characteristics, and mechanical strength, the following materials may be used. Examples of useful types of ceramics include alumina, mullite, aluminum nitride, silicon nitride and the like. Examples of useful types of glass include, crystallized glass, quartz glass, and Pyrex (registered trademark).

2. Heat Diffusion Layer

The heat diffusion layer, which functions as a means of improving the temperature uniformity in the axial direction of the heating roller, may be arranged on the top side of the conductive layer as required. For this reason, it is desirable that the heat diffusion layer be formed of a material having superior heat conduction in the axial direction of the heating roller. Materials having high thermal conductivity can often be found among metals having high electric conductivity, such as Cu, Al, Au, Ag, Pt and the like. However, the heat diffusion layer is required only to have a thermal conductivity equal to or greater than that of the material forming the conductive layer. Accordingly, the heat diffusion layer also may be formed of the same material as the conductive layer.

Furthermore, when the heat diffusion layer is formed of a conductive material, the heat diffusion layer may be in conductive contact with the conductive layer. However, the emission of radiating noise is blocked by arranging the heat diffusion layer on an insulating film. Since the effect of a high-frequency magnetic field does not reach as far as the heat diffusion layer, a secondary current that contributes to heating is not induced in the heat diffusion layer.

3. Protective Layer

A protective layer may be arranged as necessary to provide mechanical protection and electrical insulation for the heating roller, or to improve the elastic contact characteristics and toner separation characteristics of the heating roller. Glass may be used as the structural material of the protective layer for mechanical protection and electrical insulation of the heating roller, and synthetic resin may be used as the structural material of the protective layer to improve the elastic contact characteristics and the toner separation characteristics of the heating roller. The glass material used may be selected from among a group including zinc borosilicate glass, lead borosilicate glass, borosilicate glass, and aluminosilicate glass. The synthetic resin material may be selected from among a group including silicone resin, fluororesin, polyimide resin+fluororesin, and polyimide+fluororesin. In the cases of polyimide resin+fluororesin and polyimide+fluororesin, the fluororesin is disposed on the outer side.

4. Heating Roller Shape

A crown may be formed on the heating roller if desired. The crown may have a drum shape or a barrel shape.

5. Rotation Mechanism of the Heating Roller

The mechanism used to rotate the heating roller may be suitably selected from among known mechanisms. A construction may be used wherein a pressure roller is disposed opposite the heating roller, such that when a recording medium bearing a toner image passes between the heating roller and the pressure roller, the toner image is heated and fused onto the recording medium.

[Induction Coils]

In the present invention, the induction coil generates a magnetic field intersecting the heating roller to induce a secondary current in the heating roller and generates resistance heating. Thus, the induction coil serves to heat the heating roller as required. A plurality of the resistance coils are distributed along the axial direction of the heating roller in the heating roller. The structure is such that the connection at the output terminals of a high-frequency power source described later are connected to a pair of induction coils arranged at the two ends of the heating roller so as to have a certain relationship.

The plurality of induction coils are driven, that is urged or excited by a high-frequency power source either directly or through a matching circuit and/or a high-frequency transmission line, and magnetically connected to the heating roller as in, for example, an air-core transformer.

Furthermore, the induction coils may be stationary relative to the rotating heating roller, or may rotate together with or separately from the heating roller. When the induction coils are rotated, a rotating current collector mechanism may be interposed between the induction coils and a variable high-frequency power source. In this case, the “air-core transformer coupling” includes not only transformer coupling of an entire air-core, but also transformer coupling of a substantial air-core. However, electromagnetic couplings of the eddy current loss heating technique type may also be used if necessary.

The plurality of induction coils are not specifically limited regarding the winding direction of adjacent induction coils. However, the ideal relationship is the winding directions of the induction coils being mutually opposite and the generated magnetic fluxes having the same polarity, that is, being in the same direction as the heating roller.

Furthermore, the induction coils may be provided with a coil bobbin to support the coil. The coil bobbin may have a winding groove to support the induction coil in an aligned winding state. The coil bobbin may be hollow so that a power line extends therethrough to be connected to the induction coil. However, instead of a coil bobbin, the plurality of induction coils may be configured to maintain a specific shape by directly forming or adhering the induction coils using synthetic resin or glass. Furthermore, it is possible to divide the coil bobbin along the longitudinal direction, so as to accommodate the induction coil within the coil bobbin.

The induction coils may be connected to separate high-frequency power sources individually or in groups. In either case, it is preferred that the power line, which is used to supply high-frequency power from the high-frequency power source to the induction coils, be disposed at a position that is near the inner surface or the outer surface of the induction coils. When the power line extends through the induction coils, the magnetic flux that intersects the power line increases when the power line is near the center axis of the induction coils. This produces eddy current loss in the interior of the coils and undesirably reduces the power transmission efficiency. In contrast, the structure described above reduces the magnetic flux intersecting the power line, and thus suppresses the relative decrease in power transmission efficiency.

The plurality of induction coils may have the same length or different lengths. The high-frequency power supplied to the induction coils may be generally proportional to the application time of the high-frequency voltage when the high-frequency power source is shared by all induction coils. In contrast, the temperature increase of the heating roller may be influenced by the magnitude per unit length of the high-frequency power input to the induction coils. Accordingly, when the application times of the high-frequency power is the same, the relatively long induction coils will delay the temperature rise compared to relatively short induction coils. When rapidly heating to the same temperature the regions of the heating roller corresponding to a plurality of long and short induction coils while switching among the plurality of long and short induction coils, the application time of the high-frequency power may be changed proportionally to the length of the induction coils. This may be controlled by operating an induction coil selection means described later.

[High-Frequency Power Source]

The high-frequency power source is provided with a pair of output terminals, and generates a high-frequency power that is supplied to the induction coils so as to energize the plurality of induction coils. The high-frequency power source has one output terminal of the pair of output terminals set to a stable potential, and the other output terminal is set to a non-stable potential. The output terminals of the high-frequency power source may be one pair or a plurality of pairs of output terminals.

When the pair of output terminals of the high-frequency power source are connected to a pair of induction coils arranged at the two ends of the heating roller, the output terminal having a stable potential is connected to the end of the induction coil positioned at the end side of the heating roller, and the output terminal having a non-stable potential is connected to the other end of the induction coil positioned at the central side of the heating roller. The remaining induction coils are suitably connected to the pair of output terminals of the high-frequency power source.

Furthermore, although the high-frequency power source is not basically limited as to output frequency (or range of output frequencies), a high frequency output of 1 MHz or greater is effective in the case of the transformer method. By supplying a high output frequency of 1 MHz or greater, it is possible to markedly increase the Q of the induction coil to increase the power transmission efficiency. Increasing the power transmission efficiency also increases the total heating efficiency and reduces power consumption. In practice, the problem of radiation noise can be readily avoided by using a frequency of 15 MHz or lower. From the perspective of economy of compatible active elements (for example, MOSFET as described later) and ease of high-frequency noise suppression, a range of 1 to 4 MHz is preferred. The present invention may also employ the eddy current coupling method (eddy current heating method), in which case a frequency range of 20 to 100 kHz is preferred.

In generating a high frequency, it is practical to use active elements, such as semiconductor switches and the like, to directly or indirectly convert a direct current or low frequency alternating current to high frequency. When obtaining high-frequency power from a low-frequency alternating current, a rectification means may be used to convert the low-frequency alternating current to direct current. The direct current may be a smoothed direct current produced by a smoothing circuit or a non-smoothed direct current. When converting a direct current to high frequency, an amplifier and circuit elements such as an inverter and the like may be used. For example, a D-class amplifier, E-class amplifier or the like having a high power transmission efficiency may be used as an amplifier. In addition, a half-bridge type inverter also may be used. A MOSFET having superior high-frequency characteristics is desirable as an active element. A plurality of high-frequency power circuits may be connected in parallel to synthesize the high frequency output of each high-frequency power circuit before applying the high-frequency output to the induction coils. In this way, the output of each high-frequency power supply circuit may be small and a MOSFET may be used as the active device while obtaining the required power. This arrangement inexpensively and efficiently generates the high frequency power.

Furthermore, the high-frequency power source may be arranged so as to have the high-frequency power shared by a plurality of induction coils. However, a plurality of high-frequency power sources may be provided to supply power to the induction coils individually or in groups.

The output frequency of the high-frequency power source may be constant or variable. When an induction coil selection means, which will be describe later, is a switching means, a desired induction coil may be selected to supply high-frequency power to that induction coil regardless of whether the output frequency is constant or variable. In contrast, when the induction coil selection means is a filter means or a resonance circuit, the output frequency of the high-frequency power source must be variable. To make the output frequency of the high-frequency power source variable, a known frequency varying means, such as an excitation circuit, may be used to vary the oscillating frequency. Furthermore, when necessary, the input power may be greater at start-up than during normal operation for rapid heating of the roller.

[Other Structures of the Invention]

Although not required for the structural conditions of the present invention, the following structures may be selectively added to the present invention as desired to improve performance and increase functions, so as to obtain a more effective induction heating roller device.

1. Induction Coil Selection Means

The induction coil selection means is interposed between the high-frequency power source and the induction coil, and selectively controls the high-frequency power of the high-frequency power source supplied to a desired induction coil so as to effectively switch the heating region of the heating roller. The induction coil selection means may be, for example, a filter means, a resonance circuit, a switch or the like. When supplying high-frequency power to one or more induction coils among a plurality of induction coils during normal operation, an induction coil selection means need not be interposed between the target induction coil and the high-frequency power source. However, the supply of high-frequency power to the remaining induction coils may be controlled through the induction coil selection means.

Using the induction coil selection means, it is possible to change the duration of the high-frequency power applied to the induction coils. In this way, the same high-frequency power can be supplied to a first and second induction coil per unit length, and similarly the input power can be varied per unit length. The application time of the high-frequency power source may be controlled by controlling a PWM control in addition to changing the frequency. In this way, the actual application time of the input high-frequency power may differ although the actual application time is the same. The PWM control may be performed in each high-frequency half cycle, or, for example, at a relatively low frequency of 1 to 100 kHz.

2. High-Frequency Transmission Line

A high-frequency transmission line supplies high-frequency power from a high-frequency power source, through a matching circuit, if desired, to an induction coil positioned at a distance from the high-frequency power source and the matching circuit. The length of the high-frequency transmission line may be 100 mm or more. Of course, the high-frequency transmission line need not be used if it is unnecessary.

3. Matching Circuit

A matching circuit includes a circuit means for increasing the power transmission efficiency that performs impedance conversion between an internal impedance of the high-frequency power source and a load impedance when the internal impedance differs from the load impedance.

4. Coil Bobbin

The coil bobbin is formed of a material having the smallest possible induction loss and superior heat resistance to support the induction coil in a predetermined shape and position.

The coil bobbin may have a winding groove to support the coils in an aligned state. Furthermore, a high-frequency transmission connected to the induction coil may be accommodated within the hollow coil bobbin, or a power-factor improving capacitor may be accommodated within the coil bobbin.

5. Warm-Up Control

During the warm-up after actuation of the apparatus or the power supply has started, the heating roller may be controlled so as to rotate at a speed that is lower than the rotation speed during normal operation.

6. Heating Roller Temperature Control

A heat-sensitive element may be positioned in heat-conductive contact with the surface of the heating roller so as to maintain the temperature of the heating roller at a constant value within a predetermined range, for example, 200° C. The heat-sensitive element is connected to a temperature control circuit. A thermistor having negative temperature characteristics or a nonlinear resistance element having positive temperature characteristics may be used as the heat-sensitive element.

[Operation of the First Aspect of the Present Invention]

The present invention reduces the noise radiating to the outside from the two ends of the heating roller because the output terminal with stable potential is connected to each end of the pair of induction coils positioned at the two ends of the heating roller, and the output terminal with non-stable potential is connected to the other ends of the induction coils according to the elements of the previously described structure.

Furthermore, insulating is facilitated between the metal materials and the nearby pair of induction coils arranged at the two ends of the heating roller. Therefore, it is possible to minimize the distance between the metal materials and the nearby induction coils so as to attain greater compactness of the induction heating roller device, fixing devices incorporating this heating device, and image forming apparatuses incorporating the device.

In a second aspect of the present invention, an induction heating roller device includes a heating roller, a plurality of induction coils arranged within the heating roller so as to be separated in the axial direction. The heating roller is magnetically coupled with the induction coils and heated by an induction current, and the plurality of induction coils include a pair of induction coils), each having a first end positioned on an outer end portion of the heating roller and a second end positioned in the central portion of the heating roller. A high-frequency power source supplies high-frequency power to the plurality of induction coils. The high-frequency power source has a first output terminal for setting a stable potential and a second output terminal for setting a non-stable potential. The first end of each of the pair of induction coils is connected to the first output terminal, and the second end of each of the pair of induction coils is connected to the second output terminal, and all of the plurality of induction coils are connected to the first and second output terminals so as to minimize the difference in potential between adjacent ends of adjacent induction coils.

In the second aspect of the present invention, the structure facilitates insulating between the plurality of induction coils. That is, adjacent pairs of ends of the plurality of coils are connected to a pair of output terminals of a high-frequency power source so as to have the same potential. In order to realize this, at least one end of the induction coils has a shared connection so as to eliminate or reduce the difference in potential between coil ends of mutually adjacent induction coils. When some or all of the plurality of induction coils are connected in parallel to a shared high-frequency power source, the potential difference between adjacent ends of the adjacent induction coils is 0. Even when the plurality of induction coils are connected to different high-frequency power sources, for example, when an end of a plurality of induction coils share a connection to the stable potential output terminal of the high-frequency power source, the difference in potential on the shared end side becomes 0, and the difference in potential is decreased between the ends on the high potential side.

The plurality of induction coils may be divided into a plurality of groups, and selectively driven by a high frequency power from the high-frequency power source in groups. By having an even number of groups of induction coils positioned intermediately, the induction coils of the present invention are able to satisfy the stipulated conditions even between adjacent groups. There may be either an even or odd number of induction coils in the groups positioned at the end side of the heating roller.

In the second aspect of the present invention, insulating between adjacent induction coils is facilitated because the difference in electrical potential is small between the adjacent ends of mutually adjacent induction coils. Satisfactory uniformity of temperature distribution in the axial direction of the heating roller is obtained because of the ease in close arrangement of a plurality of induction coils.

In a third aspect of the present invention, an induction heating roller device includes a heating roller and a plurality of induction coils arranged within the heating roller so as to be separated in the axial direction. The heating roller is magnetically coupled with the induction coils and heated by an induction current, and the plurality of induction coils include a pair of induction coils, each having a first end positioned towards an outer end portion of the heating roller and a second end positioned towards the central portion of the heating roller. A high-frequency power source supplies high-frequency power to the plurality of induction coils. The high-frequency power source has a first output terminal for setting a non-stable potential, and a second output terminal for setting a non-stable potential. The first end of a pair of induction coils is connected to the first output terminal, and the second end of each of the pair of induction coils is connected to the second output terminal.

In the third aspect, the temperature distribution does not drop off at the two ends of the heating roller and is substantially symmetrical because the output terminal of non-stable potential is connected to the ends of the pair of induction coils disposed at the two ends of the heating roller, and the output terminal of stable potential is connected to the other end of the induction coils at the central side of the heating roller. Thus, the temperature at both ends of the heating roller is higher, and the effective length of the heating roller is increased. As a result, the heating performance of the heating roller is improved.

In a fourth aspect of the present invention, the induction heating roller device includes a heating roller and a plurality of induction coils arranged within the heating roller so as to be separated in the axial direction. The heating roller HR is magnetically coupled with the induction coils and heated by an induction current. The plurality of induction coils include a pair of induction coils, each having a first end positioned near an outer end portion of the heating roller and a second end positioned near the central portion of the heating roller. A high-frequency power source HFS supplies high-frequency power to the plurality of induction coils. The high-frequency power source has a first output terminal for setting a non-stable potential, and a second output terminal for setting a stable potential. The first end of the pair of induction coils is connected to the first output terminal, and the second end of each of the pair of induction coils is connected to the second output terminal, and all of the plurality of induction coils are connected to the first and second output terminals so as to minimize the difference in potential between adjacent ends of adjacent induction coils.

In a fifth aspect of the present invention, a fixing device is one of the induction heating roller devices according to the first through fourth aspects of the present invention including a pressure roller and a heating roller disposed in pressure contact with the pressure roller so as to fix a toner image on a recording medium as the recording medium bearing the toner image is transported between the pressure roller and the heating roller.

In the present invention, the fixing device body is the part of the fixing device remaining after removing the heating roller of the induction heating device or induction heating roller device from the fixing device.

The pressure roller and the heating roller may be disposed so as to press directly against each other, or may be disposed in indirect pressure contact through a transfer sheet when necessary. The transfer sheet may be of the endless type or roller type.

In the present invention, although the heating roller may directly contact the heated object when the heating roller heats the heated object, the heating roller may also indirectly contact the heated object through the transfer sheet passing between the heating roller and the heated object. In this case, the transfer sheet may be an endless type or a roller type. By using the transfer sheet, the heated object can be smoothly heated and transported.

In the present invention, the toner image can be fixed while the recording medium bearing the toner image is transported between the heating roller and the pressure roller.

In a sixth aspect of the present invention, an image forming apparatus includes an image forming unit for forming a toner image on a recording medium, and a fixing device of the fifth aspect of the present invention for transporting a recording medium bearing a toner image and fixing the toner image on the recording medium.

In the present invention, the image forming apparatus body is the part of the image forming apparatus remaining after removing the fixing device. The image forming means is a means of forming an image created by image information on a recording medium by an indirect method or a direct method. Indirect methods are methods of forming an image by transcription.

For example, an electrophotographic copier, printer, facsimile apparatus and the like may be used as the image forming apparatus.

Examples of recording media include transfer sheets, printing paper, electrofax sheets, electrostatic recording sheets and the like.

In the present invention, the induction heating roller device of the first through fourth aspects may be used in a high-speed image forming apparatus requiring a short warm-up time.

Other aspects and advantages of the invention will become apparent from the following description, taken in conjunction with the accompanying drawings, illustrating by way of example, the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram of an induction heating roller device according to a first embodiment of the present invention;

FIG. 2 is a partial cutaway vertical cross-sectional view of an induction coil and heating roller of the induction heating roller device of FIG. 1;

FIG. 3 is a cross-sectional view of the induction coil and heating roller of the induction heating roller device of FIG. 1;

FIG. 4 is a circuit diagram of the induction heating roller device of FIG. 1;

FIG. 5 is a schematic diagram of a fixing device provided with the induction heating roller device of FIG. 1;

FIG. 6 is a schematic diagram of an image forming apparatus provided with the fixing device of FIG. 5;

FIG. 7A is a schematic block diagram of an induction heating roller device according to a second embodiment of the present invention;

FIG. 7B is a graph showing the relationship between the temperature of a heating roller and the position of a heating roller of the induction heating roller device of FIG. 7A; and

FIG. 8 is a circuit diagram of the induction heating roller device of FIG. 7A.

### DETAILED DESCRIPTION OF THE PREFERRED EMBODIMENTS

In the drawings, like numerals are used for like elements.

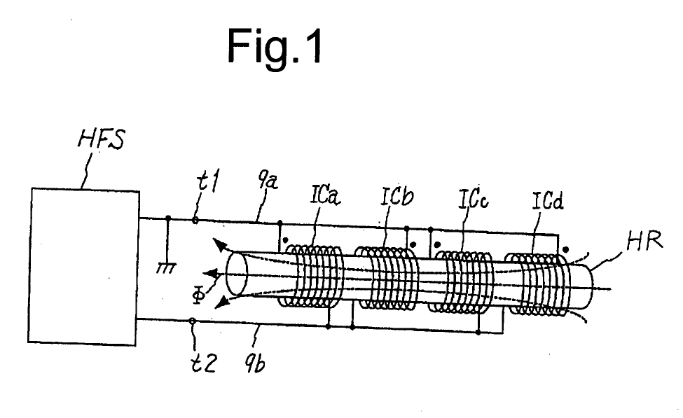

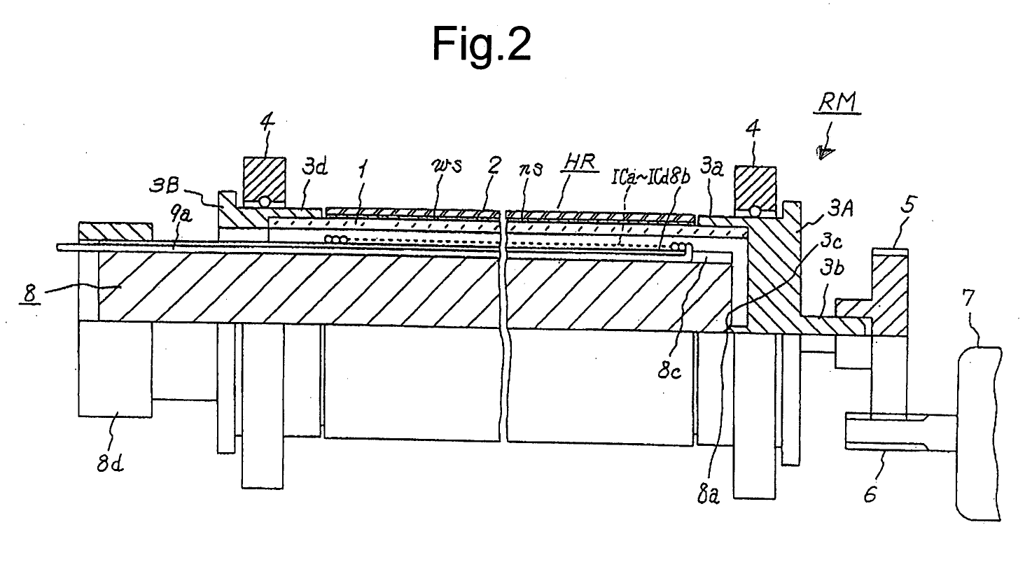

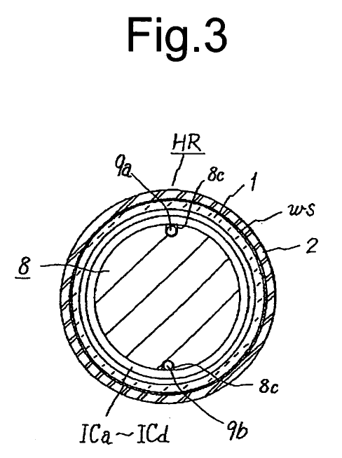

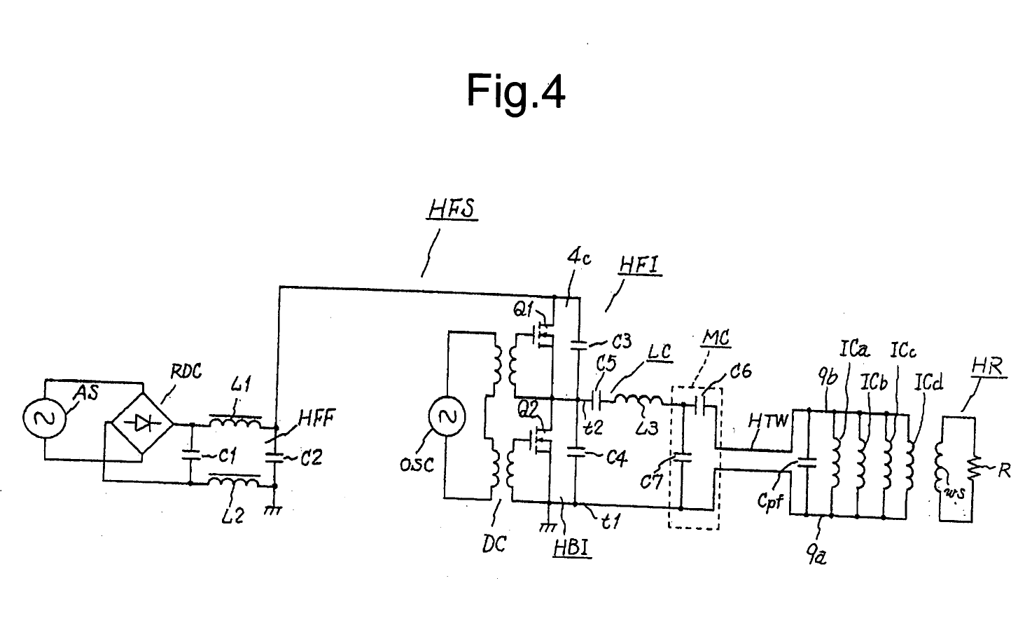

A first embodiment of the present invention is described hereinafter with reference to the drawings. FIG. 1 is a schematic block diagram showing, in its entirety, an induction heating roller device according to a first embodiment of the present invention. FIG. 2 is a partial cutaway cross-section view of an induction coil and a heating roller. FIG. 3 is a cross-sectional view of the induction coil and heating roller. FIG. 4 is a circuit diagram of the induction heating roller device.

The induction heating roller device of the first embodiment includes a heating roller HR, four induction coils ICa, ICb, ICc, and ICd, and a high-frequency power source HS. The heating roller HR is provided with a rotation mechanism RM, as shown in FIG. 2, and is driven and rotated by this mechanism. Each structural element mentioned above is described in detail below.

[Heating Roller HR]

The heating roller HR is provided with a roller base 1, a secondary coil WS, and a protective layer 2, and is rotated by a rotation mechanism RM. The roller base 1 is a cylinder formed of alumina ceramic, and has, for example, a length of 300 mm and a thickness of 3 mm. The secondary coil WS is a single-turn film-like cylindrical coil formed by Cu vapor deposition and arranged along the entire effective length of the exterior surface of the roller base 1 in the axial direction. The thickness of the secondary coil WS is set such that the value of the secondary side resistance R in the circumferential direction of the heating roller HR is 1 Ω, the value of which is substantially the same as the secondary reactance. The protective layer 2 is a fluororesin, which coats the exterior surface of the secondary coil WS.

The rotation mechanism RM is a mechanism for rotating the heating roller HR, and is configured as described below. As shown in FIG. 2, the rotation mechanism RM is provided with a first end member 3A, a second end member 3B, a pair of bearings 4, a bevel gear 5, a spline gear 6, and motor 7. The first end member 3A includes a cap 3a, a drive shaft 3b, and a tip end 3c. The left end of the cap 3a, as viewed in FIG. 2, engages the heating roller HR and is fixed to the heating roller HR by a setscrew (not shown) so as to support the left end of the heating roller. The drive shaft 3b extends outward from the outer central portion of the cap 3a. The tip end 3c extends inward from the inner central portion of the cap 3a. The second end member 3B includes a ring 3d. The ring 3d engages the right end of the heating roller HR from the outside, and is fixed to the heating roller HR by a setscrew (not shown) so as to support the right end of the heating roller HR. One of the pair of bearings 4 rotatably supports the outer surface of the cap 3a of the first end member 3A. The other one of the two bearings 4 rotatably supports the outer surface of the second end member 3B. Accordingly, the heating roller HR is rotatably supported by the first and second end members 3A and 3B, which are attached to the ends of the heating roller HR, and the pair of bearings 4. The bevel gear 5 is attached to the drive shaft 3b of the first end member 3A. The spline gear 6 is meshed with the bevel gear 5. A rotor shaft of the motor 7 is directly connected to the spline gear 6.

[Four Induction Coils ICa, ICb, ICc, and ICd]

The four induction coils ICa, ICb, ICc, and ICd are arranged so as to be adjacent to one another at small intervals along the axial direction of the heating roller HR, as shown in FIGS. 1 and 4. The end of each coil where the winding starts is attached to a power line 9a, and the end of the coil where the winding ends is attached to a power line 9b. Accordingly, the four induction coils ICa, ICb, ICc, and ICd are connected in parallel. The symbol ● is affixed to the winding starting end of the induction coils in FIG. 1. The symbol φ represents the magnetic flux generated from the four induction coils ICa, ICb, ICc, and ICd. In FIG. 4, the symbol Cpf represents a power-factor improving capacitor connected near the terminus of the high-frequency transmission line.

The four induction coils ICa, ICb, ICc, ICd are wound on a coil bobbin 8, as shown in FIGS. 2 and 3. The coil bobbin 8 is formed of a fluororesin in a cylindrical shape, and has an end face recess 8a, a coil support 8b, a groove 8c, and a cantilever support 8d. The end face recess 8a is formed at the center of the end face on the right side to prevent rotation relative to the rotation mechanism RM. The coil support 8b is formed on the exterior surface of the coil bobbin 8 so as to align the windings of the four induction coils ICa, ICb, ICc, and ICd with small gaps. The groove 8c is formed in a pipe-like configuration on the outer surface facing the center axis of the coil bobbin 8 so as to allow power lines 9a and 9b to pass into the inner part. The power lines 9a and 9b extend from the base end of the bobbin 8 to the outside, and are respectively connected to output terminals t1 and t2 of the high frequency power source HFS that will be described later. The cantilever support 8d provides cantilever support for the coil bobbin 8.

[High-Frequency Power Source HFS]

The high-frequency power source HFS, as shown in FIG. 4, includes a low-frequency alternating current (AC) source AS, direct current (DC) power source RDC, and high-frequency generator HFI. The pair of output terminals t1 and t2 of the high-frequency power source HFS are connected to the four induction coils ICa, ICb, ICc, and ICd through the series of the matching circuit MC, a high-frequency transmission line HTW, and the power lines 9a and 9b. The output terminal t1 is grounded and set to a stable potential (i.e., ground voltage), and the output terminal t2 is set to a non-stable potential (i.e., high-frequency voltage).

The low-frequency AC source AS is, for example, a commercial 100 V alternating current source.

The DC power source RDC is a rectifying circuit, which has an input terminal connected to the low-frequency alternating current source AS, converts the low-frequency alternating current voltage to a non-smoothed direct current voltage, which is output from the output terminal.

The high-frequency generator HFI has a high-frequency filter HFF, a variable high-frequency oscillator, a drive circuit DC, a half-bridge inverter main circuit HBI, a load circuit LC, and external signal source (not shown). The high-frequency filter HFF has a pair of series-connected inductors L1 and L2 connected to the two lines and a pair of capacitors C1 and C2 connected between the two lines before and after the pair of inductors L1 and L2, such that the high-frequency filter is interposed between the direct current power source RDC and the half-bridge inverter main circuit HBI to prevent the high-frequency from entering the low-frequency AC power source AS.

The high-frequency oscillator OSC is capable of variable oscillation frequencies, and generates variable high-frequency drive signals controlled by an external signal source, and the generated signals are input to the drive circuit DC. The drive circuit DC is a preamplifier, which amplifies the high-frequency signal received from the high-frequency oscillator OSC to output a drive signal. The half-bridge inverter main circuit HBI has a pair of MOSFETs Q1 and Q2, which are connected in series between the output terminals of the DC power source RDC and are alternately driven by the drive signal of the drive circuit DC, and a pair of capacitors C3 and C4 connected in parallel to the pair of MOSFETs Q1 and Q2. The half-bridge main circuit HBI converts the DC output of the DC power source RDC to a high frequency having a substantially rectangular wave. The capacitors C3 and C4 act as a high-frequency bypass during inversion operations.

The load circuit LC includes a DC cut capacitor C5, an inductor L3, and the matching circuit MC, which will be described later. Although the load circuit LC is described above as a single structural element of the high-frequency power source HFS, it may be separate from the high-frequency power source HFS. The DC cut capacitor C5 prevents a DC component from flowing to the load circuit LC from the DC power source DC side via the MOSFETs Q1, Q2. The inductor L3 and the matching circuit MC form a series resonance circuit and waveform-shapes the high frequency voltage applied to the four induction coils ICa, ICb, ICc, and ICd to a sine wave.

The waveform-shaped high-frequency voltage biases the induction coils ICa, ICb, ICc, and ICd. An external signal source OSS varies the output frequency of the high-frequency power source HFS, and controls the oscillator OSC to vary the oscillation frequency in accordance with the selected heating region.

The matching circuit MC is an impedance conversion circuit that includes a capacitor C6 connected in series, and a capacitor C5 connected in parallel to the high-frequency output line. The matching circuit MC is disposed near the high-frequency generator HFI. The impedance of the loads from the high-frequency generator HFI and matching circuit MC are matched to improve the power transmission efficiency.

[Induction Heating Roller Device Operation]

The low-frequency AC voltage of the low-frequency AC power source AS is converted to a DC voltage by the DC power source RDC, converted to a high-frequency voltage by the high-frequency power source HFS, and applied to the four induction coils ICa, ICb, ICc, and ICd. One end of the induction coils ICa and ICd arranged at the two ends of the heating roller HR are connected to the stable potential output terminal t1 of the high-frequency power source HFS. This reduces the noise radiating to the outside from the end of the heating roller HR, and also reduces the noise radiation of the grounded metal materials arranged near the end of the heating roller. Insulating is also easily accomplished between the induction coils ICa and ICd at the end of the heating roller HR and the metal material arranged near the end of the heating roller HR. Accordingly, it is possible to minimize the distance between the metal material disposed near the end of the heating roller HR and the induction coils ICa and ICd at the end of the heating roller HR.

Since the ends of all induction coils, including induction coils ICa and ICd, are connected in parallel to the output terminals t1 and t2, the difference in potential between the adjacent ends of the plurality of induction coils is minimized, and insulating between the adjacent induction coils is facilitated. The temperature distribution in the axial direction of the heating roller has satisfactory uniformity since the plurality of induction coils can be easily arranged in close proximity.

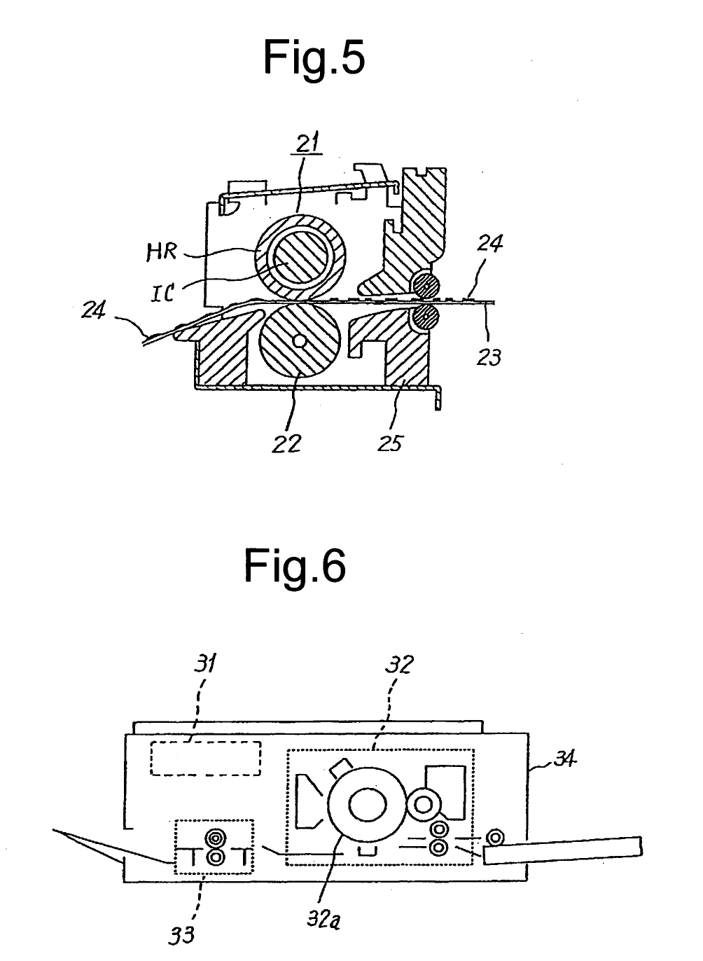

FIG. 5 is a schematic diagram of a fixing device provided with the induction heating roller device of the first embodiment of the present invention. The fixing device includes an induction heating roller device 21, a pressure roller 22, a toner 24, and a frame 25.

The first embodiment shown in FIGS. 1 through 5 are applied to the induction heating roller device 21.

The pressure roller 22 is arranged so as to press against the heating roller TR of the induction heating roller device 21, and a recording medium 23 is transported between the two rollers.

The recording medium 23 forms an image by adhering the toner 24 to the surface of the recording medium 23.

The frame 25 holds the structural elements (excluding the recording medium 23) mentioned above in predetermined positional relationships.

The fixing device transports the recording medium 23, which bears the image formed by the toner 24, in a state inserted between the heating roller TR and the pressure roller 22 of the induction heating roller device 21, and heats the toner 24 with the heat from the heating roller TR so as to melt and thermally fix the toner to the recording medium.

FIG. 6 is a schematic diagram showing a copier serving as an image forming apparatus provided with the fixing device of the present invention shown in FIG. 5. The copier includes a reading device 31, image forming means 32, fixing device 33, and an image forming apparatus case 34.

The reading device 31 optically reads a document and generates image signals.

The image forming means 32 forms an electrostatic latent image on a photosensitive drum 32a based on the image signals, and forms a reverse image by adhering toner on the electrostatic latent image, and then transcribing the image onto a recording medium such as a paper sheet or the like.

The fixing device 33 has the structure shown in FIG. 5, and heats the toner on the recording medium to melt and thermally fix the toner to the recording medium.

The image forming apparatus case 34 is provided with each of the aforesaid devices, and accommodates devices 31 through 33, and is further provided with a transport device, power source, a controller, and the like.

A second embodiment of the present invention is described below based on the drawings.

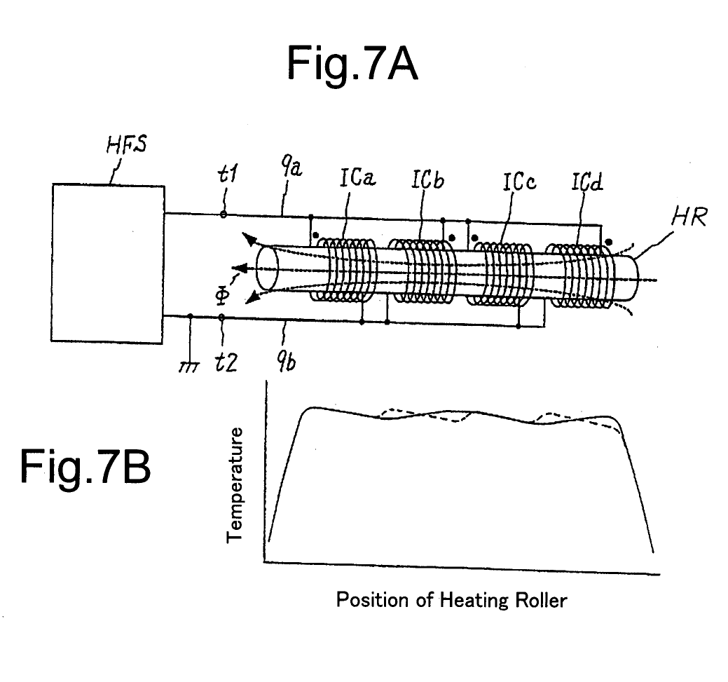

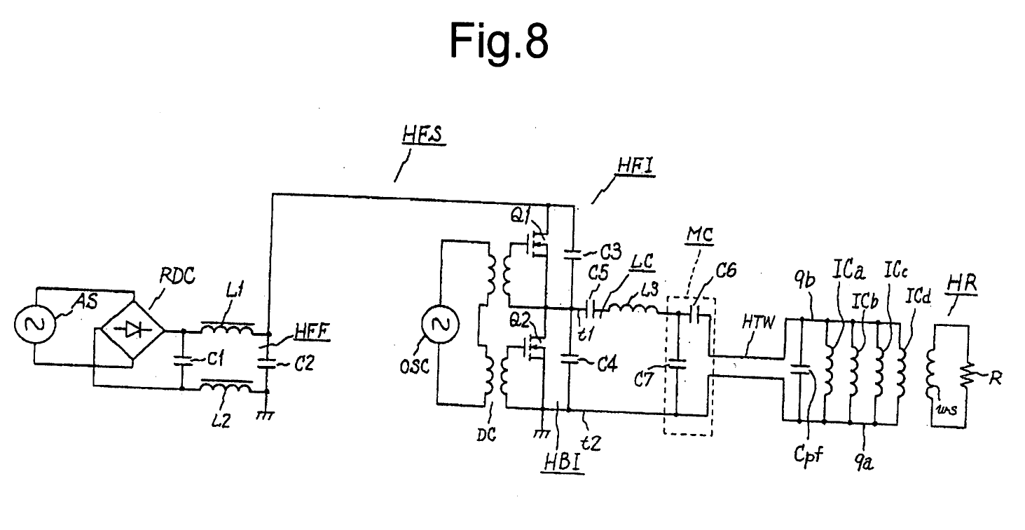

FIG. 7A is a block circuit diagram showing, in its entirety, an induction heating roller device according to a second embodiment of the present invention. FIG. 7B is a graph showing the relationship between the position of the heating roller and the temperature of the heating roller. FIG. 8 is a circuit diagram of the induction heating roller device of FIG. 7A.

In the second embodiment, the output terminal t1 of the high-frequency power source HFS is set to a non-stable potential, and the output terminal t2 is grounded and set to a stable potential, as shown in FIGS. 7A and 8. The matching circuit MC, the high-frequency transmission line HTW, and the power lines 9a and 9b shown in FIG. 1 are eliminated.

In the induction heating roller device, the low-frequency AC voltage of the low-frequency AC power source AS is converted to a DC voltage by the DC power source RDC, then converted to a high-frequency voltage by the high-frequency power source HFS and applied to the four induction coils ICa, ICb, ICc, and ICd. The ends of the induction coils ICa and ICd positioned at both ends of the heating roller HR are connected to the non-stable potential output terminal t1 of the high-frequency power source HFS, and the other ends of the induction coils ICa and ICd are connected to the output terminal t2 having a stable potential. Accordingly, the temperature is distributed along the axial direction of the heating roller HR as indicated by the solid line in the graph of FIG. 1.

The temperature in the part of the heating roller HR corresponding to the induction coils ICa and ICd tends to gradually increase in the direction from the end of the induction coils in the center part toward the other end near the end of the heating roller. Accordingly, the temperature distribution at the two ends of the heating roller HR does not drop off, and the temperature is distributed with substantial symmetry at the bilateral ends of the heating roller HR. The temperature of both ends and the center of the heating roller HR is thus increased and the heating performance is improved.

The temperature distribution is indicated by the dashed line in FIG. 7B when the output terminal t1 of the high-frequency power source HFS is connected to the induction coil ICa opposite the ends of the heating roller HR in the same manner as in the second embodiment, and the output terminal t2 is connected to an end of the induction coil ICd positioned at the other end of the heating roller HR. It can be understood from this illustration that a drop off in the temperature distribution occurs on the right side, the temperature distribution at the two ends of the heating roller HR is asymmetric, and the temperature is reduced on the right side. Furthermore, the temperature distribution in the center of the heating roller HR is irregular.

The induction heating roller device of the second embodiment may also be used as the induction heating roller device 21 of FIG. 5, and may also be used as the induction heating roller device of the fixing device 33 in the image forming apparatus 34 of FIG. 6.

It should be apparent to those skilled in the art that the present invention may be embodied in many other specific terms without departing from the spirit or scope of the invention. Therefore, the present examples, and embodiments are to be considered as illustrative and not restrictive and the invention is not to be limited to the details given herein, but may be modified within the scope and equivalence of the appended claims.

What is claimed is:

1. An induction heating roller device comprising:
a heating roller having outer end portions, a central portion, and opposite ends;
a plurality of induction coils arranged in the heating roller so as to be separated in the axial direction, wherein the heating roller is magnetically coupled with each induction coil for heating by induction current, and the plurality of induction coils include a pair of induction coils with one induction coil of the pair arranged at one end of the heating roller and the other induction coil of the pair arranged at the opposite end of the heating roller, each of induction coils of the pair having a first end positioned nearer an end portion of the heating roller and a second end positioned nearer a central portion of the heating roller; and
a high-frequency power source for supplying high-frequency power to the plurality of induction coils, the high-frequency power source including a first output terminal set at a stable potential and a second output terminal set at a non-stable potential, with the first end of each of the pair of induction coils connected to the first output terminal, and the second end of each of the pair of induction coils connected to the second output terminal.

2. The induction heating roller device of claim 1, wherein all of the plurality of induction coils are connected to the first and second output terminals so as to decrease the difference in potential between adjacent ends of adjacent induction coils.

3. The induction heating roller device of claim 1, wherein the stable potential is a ground voltage and the non-stable potential is a high-frequency voltage.

4. A fixing device for use with a recording medium bearing a toner image, the fixing device comprising:
a pressure roller; and
an induction heating roller device including a heating roller arranged in pressure contact with the pressure roller, wherein the heating roller transports the recording medium bearing a toner image by holding the recording medium with the pressure roller and fixes the toner image on the recording medium, the induction heating roller device further including:
a plurality of induction coils arranged in the heating roller so as to be separated in the axial direction, wherein the heating roller is magnetically coupled with each induction coil for heating by induction current, and the plurality of induction coils include a pair of induction coils with one induction coil of the pair arranged at one end of the heating roller and the other induction coil of the pair arranged at the opposite end of the heating roller, each of induction coils of the pair having a first end positioned nearer an end portion of the heating roller and a second end positioned nearer a central portion of the heating roller; and
a high-frequency power source for supplying high-frequency power to the plurality of induction coils, the high-frequency power source including a first output terminal set at a stable potential and a second output terminal set at a non-stable potential, with the first end of each of the pair of induction coils connected to the first output terminal, and the second end of each of the pair of induction coils connected to the second output terminal.

5. The fixing device of claim 4, wherein all of the plurality of induction coils are connected to the first and second output terminals so as to decrease the difference in potential between adjacent ends of adjacent induction coils.

6. The fixing device of claim 4, wherein the stable potential is a ground voltage and the non-stable potential is a high-frequency voltage.

7. An image forming apparatus for use with a recording medium, the image forming apparatus comprising:
an image forming unit for forming a toner image on the recording medium;
a fixing device for transporting the recording medium bearing the toner image and fixing the toner image on the recording medium, the fixing device including:
a pressure roller; and
an induction heating roller device including a heating roller arranged in pressure contact with the pressure roller, wherein the heating roller transports the recording medium bearing a toner image by holding the recording medium with the pressure roller and fixes the toner image on the recording medium, the induction heating roller device further including:
a plurality of induction coils arranged in the heating roller so as to be separated in the axial direction, wherein the heating roller is magnetically coupled with each induction coil for heating by induction current, and the plurality of induction coils include a pair of induction coils with one induction coil of the pair arranged at one end of the heating roller and the other induction coil of the pair arranged at the opposite end of the heating roller, each of induction coils of the pair having a first end positioned nearer an end portion of the heating roller and a second end positioned nearer a central portion of the heating roller; and
a high-frequency power source for supplying high-frequency power to the plurality of induction coils, the high-frequency power source including a first output terminal set at a stable potential and a second output terminal set at a non-stable potential, with the first end of each of the pair of induction coils connected to the first output terminal, and the second end of each of the pair of induction coils connected to the second output terminal.

8. The image forming apparatus of claim 7, wherein all of the plurality of induction coils are connected to the first and second output terminals so as to decrease the difference in potential between adjacent ends of adjacent induction coils.

9. The image forming apparatus of claim 7, wherein the stable potential is a ground voltage and the non-stable potential is a high-frequency voltage.

10. An induction heating roller device comprising:
a heating roller having outer end portions, a central portion, and opposite ends;
a plurality of induction coils arranged in the heating roller so as to be separated in the axial direction, wherein the heating roller is magnetically coupled with each induction coil for heating by induction current, and the plurality of induction coils include a pair of induction coils with one induction coil of the pair arranged at one end of the heating roller and the other induction coil of the pair arranged at the opposite end of the heating roller, each of induction coils of the pair having a first end positioned nearer an end portion of the heating roller and a second end positioned nearer a central portion of the heating roller; and
a high-frequency power source for supplying high-frequency power to the plurality of induction coils, the high-frequency power source including a first output terminal set at a non-stable potential and a second output terminal set at a stable potential, with the first end of each of the pair of induction coils connected to the first output terminal and the second end of each of the pair of induction coils connected to the second output terminal.

11. The induction heating roller device of claim 10, wherein all of the plurality of induction coils are connected to the first and second output terminals so as to decrease the difference in potential between adjacent ends of adjacent induction coils.

12. The induction heating roller device of claim 10, wherein the stable potential is a ground voltage and the non-stable potential is a high-frequency voltage.

13. A fixing device for use with a recording medium bearing a toner image, the fixing device comprising:
a pressure roller; and
an induction heating roller device including a heating roller arranged in pressure contact with the pressure roller, wherein the heating roller transports the recording medium bearing a toner image by holding the recording medium with the pressure roller and fixes the toner image on the recording medium, the induction heating roller device further including:
a plurality of induction coils arranged in the heating roller so as to be separated in the axial direction, wherein the heating roller is magnetically coupled with each induction coil for heating by induction current, and the plurality of induction coils include a pair of induction coils with one induction coil of the pair arranged at one end of the heating roller and the other induction coil of the pair arranged at the opposite end of the heating roller, each of induction coils of the pair having a first end positioned nearer an end portion of the heating roller and a second end positioned nearer a central portion of the heating roller; and
a high-frequency power source for supplying high-frequency power to the plurality of induction coils, the high-frequency power source including a first output terminal set at a non-stable potential and a second output terminal set at a stable potential, with the first end of each of the pair of induction coils connected to the first output terminal, and the second end of each of the pair of induction coils connected to the second output terminal.

14. The fixing device of claim 13, wherein all of the plurality of induction coils are connected to the first and second output terminals so as to decrease the difference in potential between adjacent ends of adjacent induction coils.

15. The fixing device of claim 13, wherein the stable potential is a ground voltage and the non-stable potential is a high-frequency voltage.

16. An image forming apparatus for use with a recording medium, the image forming apparatus comprising:
an image forming unit for forming a toner image on the recording medium;
a fixing device for transporting the recording medium bearing the toner image and fixing the toner image on the recording medium, the fixing device including:
a pressure roller; and
an induction heating roller device including a heating roller arranged in pressure contact with the pressure roller, wherein the heating roller transports the recording medium bearing a toner image by holding the recording medium with the pressure roller and fixes the toner image on the recording medium, the induction heating roller device further including:
a plurality of induction coils arranged in the heating roller so as to be separated in the axial direction, wherein the heating roller is magnetically coupled with each induction coil for heating by induction current, and the plurality of induction coils include a pair of induction coils with one induction coil of the pair arranged at one end of the heating roller and the other induction coil of the pair arranged at the opposite end of the heating roller, each of induction coils of the pair having a first end positioned nearer an end portion of the heating roller and a second end positioned nearer a central portion of the heating roller; and
a high-frequency power source for supplying high-frequency power to the plurality of induction coils, the high-frequency power source including a first output terminal set at a non-stable potential and a second output terminal set at a stable potential, with the first end of each of the pair of induction coils connected to the first output terminal, and the second end of each of the pair of induction coils connected to the second output terminal.

17. The image forming apparatus of claim 16, wherein all of the plurality of induction coils are connected to the first and second output terminals so as to decrease the difference in potential between adjacent ends of adjacent induction coils.

18. The image forming apparatus of claim 16, wherein the stable potential is a ground voltage and the non-stable potential is a high-frequency voltage.
